(19) United States
(12) Patent Application Publication
(10) Pub. No.: US 2010/0089220 A1
(43) Pub. Date: Apr. 15, 2010

(54) MULTI FREQUENCY MERGER MUSIC DEVICE

(76) Inventor: LAZARO ALFONSO, Miami, FL (US)

Correspondence Address: EDAM LAW PLLC;Edmar M. Amaya Esq., InterAmerican Plaza, 701SW 27th AVE Suite GR9, Miami, FL, 33135, US

(21) Appl. No.: 12/578,527

(22) Filed: Oct. 13, 2009

Related U.S. Application Data
(60) Provisional application No. 60/962,013, filed on Oct. 10, 2008.

(51) Int. Cl. G10G 7/02; G10D 9/00

(52) U.S. Cl. 84/454; 84/453

(57) ABSTRACT

A music device comprising a large acoustic frequency chamber, the chamber further comprising an elastic membrane placed on the acoustic chamber. It also comprises, at least one tightening ring and one tightening tuning device, where the tightening tuning device is anchored to a tightening ring and an elastic membrane. The device further comprises one small acoustic frequency chamber that contains another elastic membrane and a second tightening ring. Both chambers combine acoustic frequencies to produce a single combined acoustic frequency. The music tuning device is used both to clasp at least one drum skin and to mask unharmonic resonances.

### CROSS REFERENCE TO RELATED APPLICATION

This application is a Non-provisional application which claims the benefit of priority under 35 U.S.C. Section 119 from U.S. Provisional Application “TUMBATA” No. 60/962,013 FILED ON Oct. 10, 2008.

### BACKGROUND OF THE TECHNOLOGY

Throughout the African continent, drums of different sizes, types and materials were played. The migration of bongo drums occurred during the slave trade from Africa to South America. The West Indies was and is enamored with the bongo drum, as evidenced in the musical created in countries such as Cuba.

Bongo type drums vary by location. In Morocco and Egypt, they were historically constructed with ceramic bodies, while the drum skin would be made of rawhide or goatskin. While the Middle Eastern tradition includes ceramic bongos, South American bongos are typically made of wood, due to the fact that the wooden bongos were brought there from Africa. Every culture is associated with some kind of drum even though contemporary music often involves drums from all around the world in a single performance. Bongo drums have a distinct sound, higher pitched than larger drums, such as the ones used in Japan and other Asian countries, and modern bongo drummers may wield sticks or brushes.

Bongo and Conga drums are members of the percussion family of musical instruments because they produce sound by being hit, or struck, either by a hand or another object. To adjust the tones of a bongo, the player can lay his palm on the drum skin while striking it. The drummers use their fingertips, as well as their palms, to create complex sounds. Even so, the bongo-drummer is never able to create a combination of higher and lower pitches in a single instrument.

One of the issues with today's smaller, higher pitch bongo drums is that a bongo drummer holds the drums between the knees, placing the larger drum head beneath the hand they favor. This is an uncomfortable position since the legs act as damper for the impact force placed on the drum skin. This position in many cases causes the extremities to deform and old drummers develop chronic arthritis in the knees.

Another issue with the current bongo drums is that they only provide for a single pitch or acoustic frequency. Similarly, conga drums do not produce a wide range of pitches. Two or three bongo and conga drummers are usually required in order to produce a rhythm for a piece of music.

Today's bongo drummers do not have the possibility of using a single comfortable instrument to produce a combined rhythm. Furthermore, there is nothing in the drum-music world that uses the tension-heads to produce sounds complementing the drum. There is also a need in the music marketplace to have an instrument that complements and merges the sounds of the conga and the bongo.

### BRIEF DESCRIPTION OF THE SEVERAL VIEWS OF THE DRAWINGS

The foregoing summary, as well as the following detailed description of the technology, will be better understood when read in conjunction with the appended drawings. For illustrating the technology, they are shown in the embodiments, which are presently preferred. It should be understood, however, that the technology is not limited to the precise arrangements and instrumentalities shown. In the drawings:

FIG. 1 depicts one side view of at least one embodiment of the technology, where the combination of acoustic frequencies is accomplished by joining multiple chambers as a single instrument.

FIG. 2 depicts at least one embodiment of the technology, where two small acoustics frequencies are combined into a single main chamber.

FIG. 3 depicts at least one embodiment of the technology, where the music tuning device produces at least one sound outside the instrument.

FIG. 4 depicts at least one embodiment of the technology, where the music tuning device is meticulously depicted.

FIG. 5 depicts at least one cross section of one embodiment of the technology, where the music tuning device produces at least one type of sound.

FIG. 6 depicts at least one cross section of one embodiment of the technology, where the music tuning device produces another type of sound.

FIG. 7 depicts at least one cross section of one embodiment of the technology, where the music tuning device produces yet another type of sound.

FIG. 8 depicts at least one embodiment of the technology, it further depicts how at least one angular dimension is needed for the creation of at least one acoustic frequency combination.

FIG. 9 depicts one top view of at least one the embodiment of the technology, it further depicts how at least one angular dimension is needed for the creation of at least one acoustic frequency combination.

### DESCRIPTION OF THE TECHNOLOGY

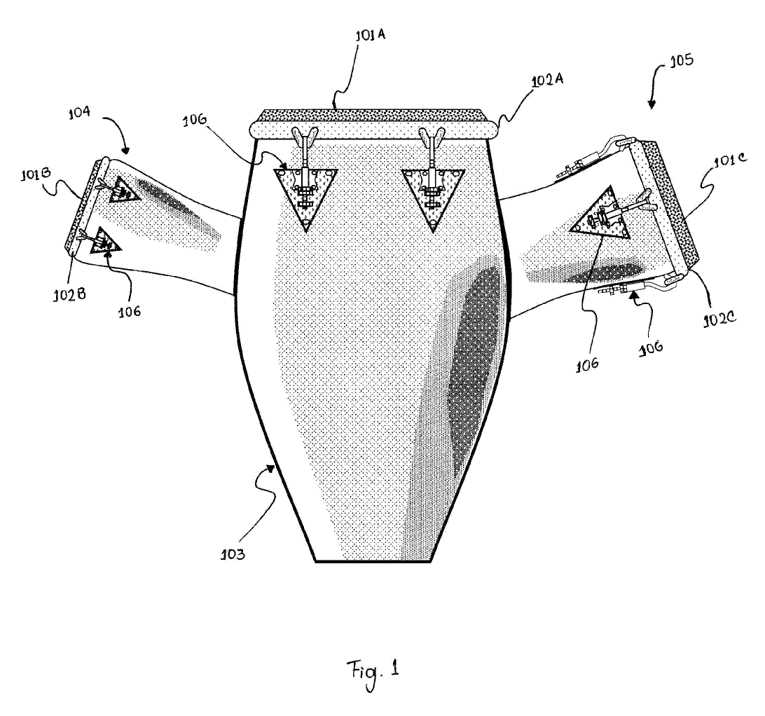

The disclosed technology consists of at least two drums 103, 104, 105 that are connected to create a single large acoustic chamber 204A. Typically, one drum will be larger than the other FIG. 1. The drum chamber walls 205 are made of wood, metal, or a combination of materials including material composites. The drum elastic membranes 101A, 101B, 101C are either animal skin or a man-made material, such as rubber, plastic or polymer material composites. The drum elastic membranes 101A, 101B, 101C can be stretched and adjusted to create diverse sounds. Particularly, the drum elastic membranes 101A, 101B, 101C where tensioned by at least one tightening ring 102, and at least one tightening tuning device 106. The drums in FIG. 1 may fit into drum stands for prolonged and improved instrumentation.

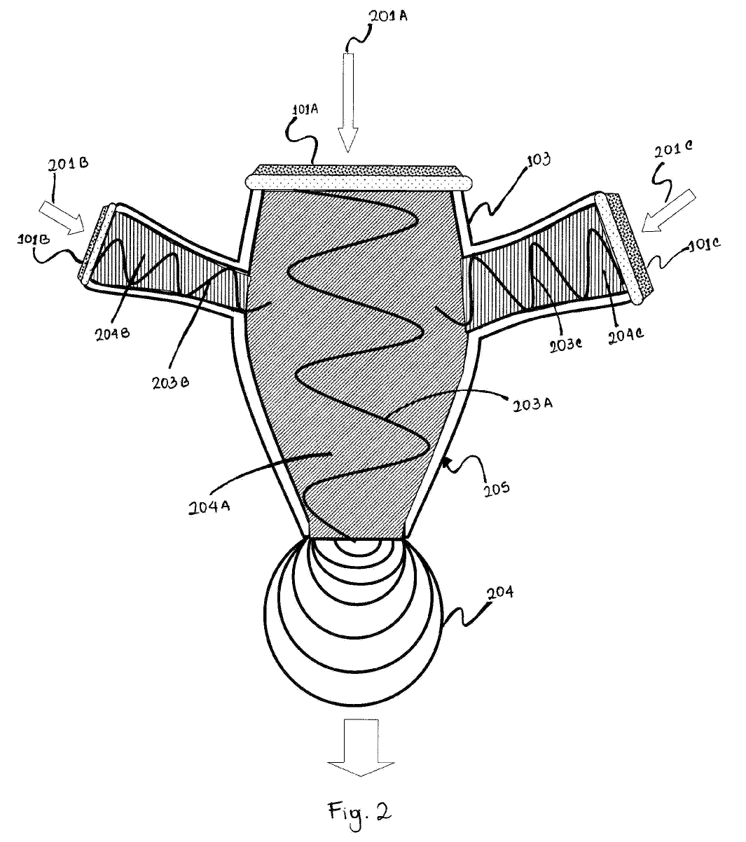

The drum elastic membranes 101A, 101B, 101C are stretched across at least one acoustic frequency chamber 205 and held in place with a tightening ring 102 and a tightening tuning device 106. When the drum elastic membranes 101A, 101B, 101C are hit by the drummer's hand or drum stick, the drum elastic membranes 101A, 101B, 101C vibrate, which produces sound waves 203A, 203B, 203C. The sound is amplified due to the material in the acoustic chambers 204A, 204B, 204C itself The larger the acoustic chamber 204A, the lower its pitch; the smaller the acoustic chamber 204B, 204C, the higher its pitch. The inventive technology merges the sound waves 203A, 203B, 203C and produces a single combined acoustic frequency 204, as seen in FIG. 2.

The amplitude or volume produced in the acoustic chambers 204A, 204B, 204C is adjusted by changing the force 201A, 201B, 201C with which one hits the elastic membranes 101A, 101B, 101C. The user can stop, or dampen, the sound by touching the head of the elastic membranes 101A, 101B, 101C with their hand. This stops the vibration right away. Drum sticks made of different materials my also be used along with the inventive technology of FIG. 1, each of which produce different sounds.

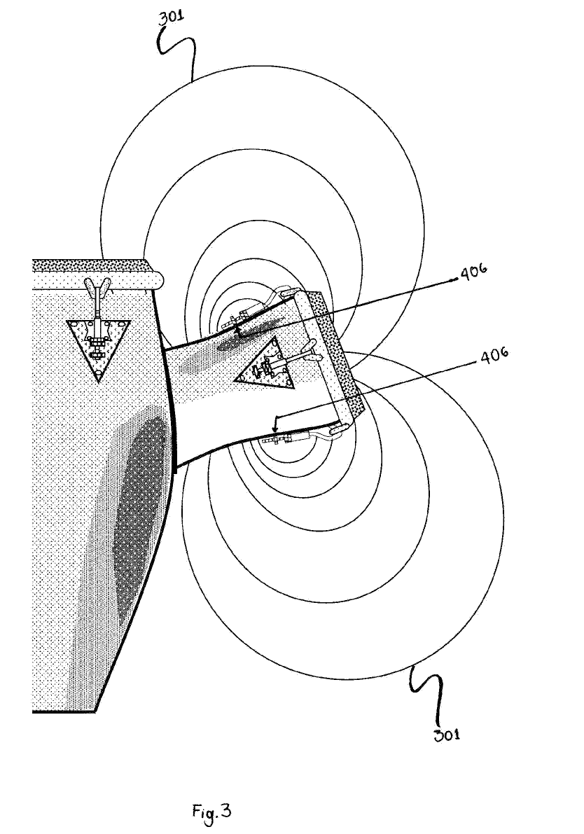

The “heads” of the drum elastic membranes 101A, 101B, 101C are made of the materials selected from the group consisting of animal skin, rubber, plastic and polymer material composites. Ingeniously the elastic membranes 101A, 101B, 101C are now controlled with tension by said at least one tightening ring 102A, 102B, 102C, and said at least one tightening tuning device 106. FIG. 3 depicts how depending on how the tuning device 106 is tightened, different vibrational acoustic frequencies and a ringing sound 301 can be achieved when the elastic membranes 101A, 101B, 101C are struck. The tightening music tuning device 106 is intermittently placed on the exterior of the acoustic frequency chamber wall 205.

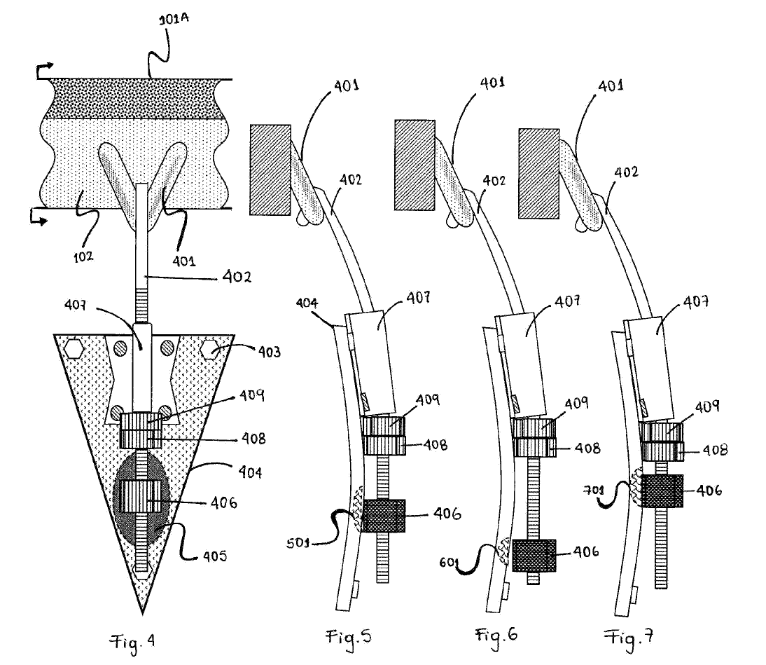

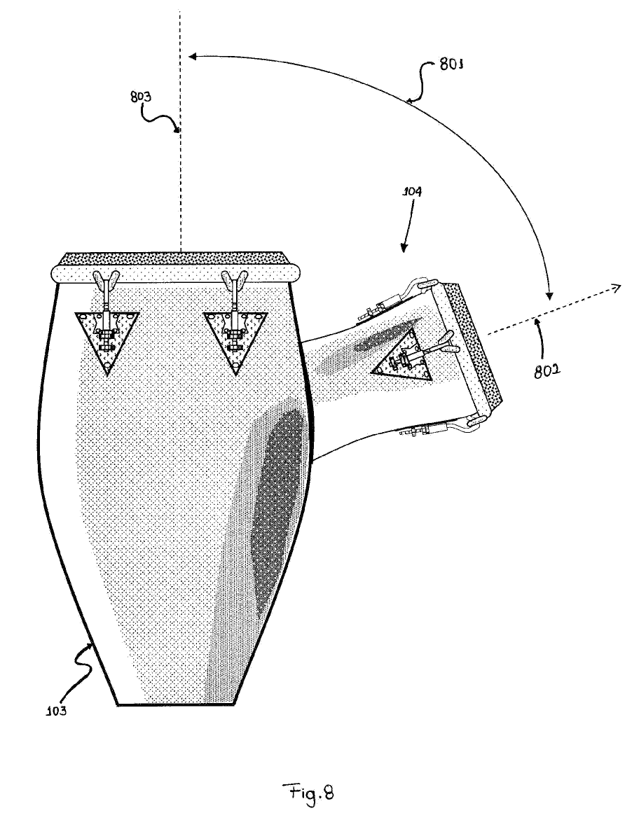

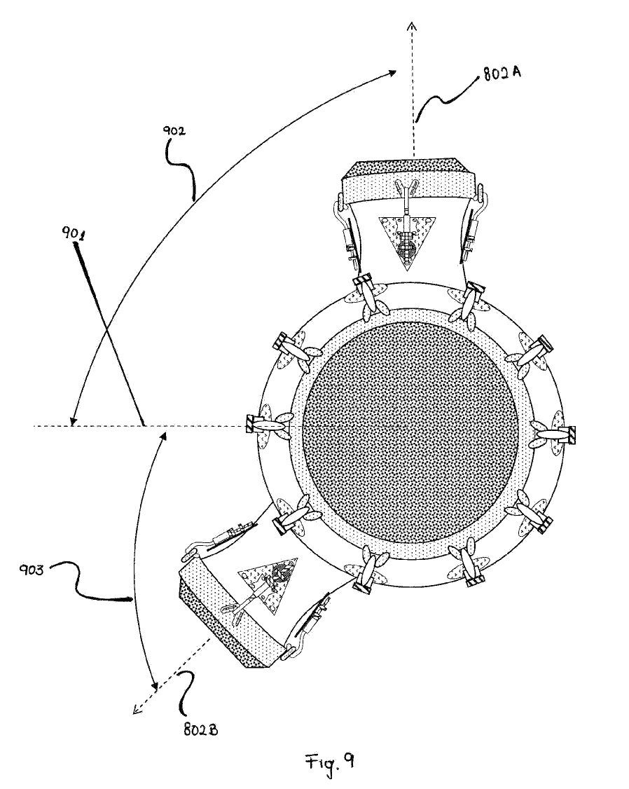

FIG. 4 depicts, in detail, the innovative music tuning device 106. The tuning device 106 comprises a tightening ring 102, the tightening ring 102 further comprising at least one hoop 401 that is axially deposed onto the tightening ring 102. The music tuning device 106 creates the tension in the elastic membranes 101A, 101B, 101C using at least one tightening rod hook 402, demountably clasped to at least one hoop 401 in said at least one tightening ring 102 by means of at least one tightening bolt 408, 409, the tightening bolts 408, 409 concentrically sliding on the tightening rod hook 402. The tuning device 106 further comprises at least one sound plate 404 and at least one sound plate attachment 407. The sound plate attachment is 407 securely placed onto said at least one sound plate 404. The sound plate 404 is placed onto the outside wall 205 by using the attachments 403 selected from the group consisting of bolts, rivets and solder. The tuning device 106 further comprises at least one vibrating weight 406, the vibrating weight 406 concentrically sliding tightening rod hook 402 and striking intermittently the sound plate 404 at impact zones 501, 601, 701 creating different ringing sounds 301. The quantity of the weight 406 can be changed and lighter weight creates different ringing sounds as well.

The tighter the vibrating weight 406, as in FIG. 7, the deeper (slower) the sound emitted 301, while the looser the vibrating weight 406, as in FIG. 6, the higher (faster) the sound produced 301. The vibrations 301 are also controlled by how the player strikes the elastic membranes 101A, 101B, 101C. Similarly, a dampened sound occurs when the player strikes the elastic membranes 101A, 101B, 101C while with one's thumb loosens the tightening bolts 408, 409 as in FIG. 5, or by striking the tightening ring 102, thus minimizing the vibrations of the elastic membranes 101A, 101B, 101C. Striking in the center with a full hand, however, maximizes the vibrations of the elastic membranes 101A, 101B, 101C, making for a louder, more energetic combination of sound 301 and 204. The acoustic chambers 204A, 204B, 204C are played using the fingertips, open palms or parts of the hand. Striking the elastic membranes 101A, 101B, 101C causes ripples of energy along the chamber wall 205; if slowed down, they would resemble the rings in a pond when a stone is thrown in as depicted in FIG. 2. The faster the combined frequency rings move out 204, the faster the acoustic chambers 204A, 204B, 204C vibrates, and adding the ringing sound of the vibrating weight 406 against the plates 404, the higher the pitch becomes.

FIG. 8 depicts at least one embodiment of the technology; the smaller bongo type drum 104 is ingeniously mounted on the side of the larger acoustic chamber 204A. This configuration allows for a more comfortable playing position thus avoiding the physiological problems described in the background of the inventions. The size of the acoustic chambers 204A, 204B, 204C also has an effect on the sound 204 that is generated. The smaller drums 104 and 105 tend to produce higher notes than the larger drum 103. This is because the smaller elastic membranes such as 101C are under greater tension, and because the acoustic chamber 204C of the drum is smaller, thus affecting the speed of the sound waves as they enter the large acoustic chamber 204A.

In one embodiment of the technology, the acoustic chambers 204A, 204B, 204C were crafted of wood, in particular Mahogany. Another embodiment was made of oak. The wood vibrates the entire structure 103 when the elastic membranes 101A, 101B, 101C are struck. The forces 201A, 201B, 201C of the impact on the elastic membranes 101A, 101B, 101C causes sound waves to bounce off the wood, altering the frequency slightly. Other, softer woods, would absorb more of these sound waves 203 A, 203 B, 203 C and result in a “dull” or “flat” combination sound 204. Oak and mahogany are harder woods, and so reflect the sound waves 203 A, 203 B, 203 C in the larger acoustic chamber 204A more clearly. In yet another embodiment the acoustic chambers 204 A, 204B, 204C are made of fiberglass. Fiberglass offers a lighter weight, more durable body and lower cost than wood models, without sacrificing the acoustic value of a hard surface.

FIG. 8 and FIG. 9 depict two embodiments of the disclosed technology. In FIG. 8, the smaller acoustic chamber 204B, is placed using a defined 30 degree angle 801. After many experiments it was found that when the smaller acoustic chamber 204B positioned between angle 0 and 180 degrees in relation (X-Y) plane to the perpendicular vector 803 of elastic membranes 101A, the sound 204 changes; and, further more, the position to the drummer is more comfortable. Likewise, in FIG. 9, the sound was modified, thus the acoustic chambers 204B, 204C, were positioned at angles 45 degrees 902 and 30 degrees 903, respectively, thus between angle 0 and 360 degrees in relation to the (Z-X) axis of the said at least one large frequency chamber perpendicular vector 803.

In one embodiment of the technology, in FIG. 8, acoustic chambers 204A and 204C create a mixture of harmonic and unharmonic resonances when they are played 204. The unharmonic resonances are more pronounced, resulting in discordant “noise” more often than music. After the adjusting of the tightening tuning devices 106 the unharmonic resonances were controlled or minimized (possibly even masked) by the different ringing sounds 301. Studies comparing the harmonics 204 coming out of acoustic chambers 204A, 204B, 204C reveal these differences scientifically.

It will be appreciated by those skilled in the art that changes could be made to the embodiments described above without departing from the broad inventive concept thereof. It is understood, therefore, that this technology is not limited to the particular embodiments disclosed, but it is intended to cover modifications within the spirit and scope of the present technology.

We claim:

1. A music device comprising:
at least one large acoustic frequency chamber, said large acoustic frequency chamber further comprising at least one first elastic membrane depicted on said large acoustic chamber, at least one first tightening ring, and at least one first tightening tuning device, said at least one first tightening tuning device anchored demountably to said first tightening ring and said first elastic membrane; and
at least one small acoustic frequency chamber, said small acoustic frequency chamber further comprising at least one second elastic membrane depicted on said small acoustic chamber, at least one second tightening ring, and at least one second tightening tuning device, said at least one second tightening tuning device anchored demountably to said second tightening ring and said second elastic membrane;
wherein said at least one large acoustic frequency chamber and said at least one small acoustic frequency chamber combine acoustic frequencies to produce a single combined acoustic frequency.

2. The music device of claim 1, wherein the said at least one large acoustic frequency chamber and said at least one small frequency chamber are made of the materials selected from the group consisting of wood, metal, carbon fiber, glass fiber and synthetic wood type material composites.

3. The music device of claim 1, wherein the said at least one first elastic membrane and said at least one second elastic membrane are made of the materials selected from the group consisting of animal skin, rubber, plastic and polymer material composites.

4. The music device of claim 1, wherein the said at least one first elastic membrane is tensioned by said at least one first tightening ring and said at least one first tightening tuning device.

5. The music device of claim 1, wherein the said at least one second elastic membrane is tensioned by said at least one second tightening ring and said at least one second tightening tuning device.

6. The music device of claim 1, wherein the said at least one first elastic membrane and said at least one second elastic membrane vibrate to create at least one first acoustic frequency and at least one second acoustic frequency to merge together into said at least one large acoustic frequency chamber.

7. The music device of claim 1, wherein the said at least one first tightening tuning device is intermittently deposed on the exterior of said at least one large acoustic frequency chamber, whereby creating a ringing sound.

8. The music device of claim 1, wherein the said at least one second tightening tuning device is intermittently deposed on the exterior of said at least one small acoustic frequency chamber, whereby creating a ringing sound.

9. The music device of claim 1, wherein the said at least one small frequency chamber, is positioned between angle 0 and 180 degrees in relation to the (X-Y) plane and to the perpendicular vector of said at least one first elastic membrane.

10. The music device of claim 1, wherein the said at least one small frequency chamber is positioned between angle 0 and 360 degrees at the (Z-X) plane in relation to the said at least one large frequency chamber perpendicular vector.

11. A music tuning device comprising:
at least one tightening ring, said tightening ring further comprising at least one hoop axially deposed onto said at least one tightening ring;
at least one tightening rod hook, demountably clasped to said at least one hoop in said at least one tightening ring;
at least one tightening bolt, said tightening bolt concentrically sliding on said at least one tightening rod hook;
at least one sound plate;
at least one sound plate attachment, said sound plate attachment securely deposed onto said at least one sound plate; and
at least one vibrating weight, said vibrating weight concentrically sliding on said at least one tightening rod hook and intermittently striking said at least one sound plate.

12. The music tuning device of claim 11, wherein said music tuning device is made of metal.

13. The music tuning device of claim 11, wherein said sound plate is deposed on to the outside of at least one drum.

14. The music tuning device of claim 11, wherein said sound plate is deposed on to the outside of at least one drum by using the attachments selected from the group consisting of bolts, rivets and solder.

15. The music tuning device of claim 11, wherein said tuning device is used to tighten at least one elastic membrane of at least one acoustic frequency chamber.

16. The music tuning device of claim 11, wherein said vibrating weight is adjusted to vibrate by changing the quantity of the weight to create different ringing sounds.

17. The music tuning device of claim 11, wherein said vibrating weight is adjusted to vibrate by changing the position in said at least one tightening rod hook, whereby creating different ringing sounds.

18. The music tuning device of claim 11, wherein said tuning device is used both to clasp at least one vibrating membrane and to control unharmonic resonances.

19. The music tuning device of claim 11, wherein said tuning device is used both to clasp at least one vibrating membrane and to create at least one ringing sound.

20. The music tuning device of claim 11, wherein said tuning device is used both to clasp at least one drum skin and to mask unharmonic resonances.
